(19) United States
(12) Patent Application Publication
(10) Pub. No.: US 2024/0303669 A1
(43) Pub. Date: Sep. 12, 2024

(54) SYSTEMS AND METHODS FOR MANUFACTURING ENERGY CONSUMPTION AND CARBON FOOTPRINT ATTRIBUTION

(71) Applicant: Devices-Unlimited Corp., Santa Ana, CA (US)

(72) Inventors: Ashok MURTHY, RMV, CA (US); Yoshiaki TAKAHASHI, Yokohama (JP)

(73) Assignee: Devices-Unlimited Corp., Santa Ana, CA (US)

(21) Appl. No.: 18/180,503

(22) Filed: Mar. 8, 2023

(51) Int. Cl. G06Q 30/018; G06Q 50/04

(52) U.S. Cl. CPC G06Q 30/018; G06Q 50/04

(57) ABSTRACT

According to at least one exemplary embodiment a method for determining the carbon footprint of a manufactured item may be provided. The method may begin by determining one or more subcomponent carbon footprint (UMX) values based on a carbon footprint associated with the one or more subcomponents. Then the subcomponent UMX value may be associated with the subcomponent through a subcomponent identifier. The process may then be repeated for each of one or more subsequent components and/or final products.

### BACKGROUND

Current energy measurement devices used to determine energy consumption during manufacturing are not fast enough to accurately identify and map the power consumption cycle used in high-speed manufacturing environments. In some cases, an individual manufacturing process step may have a cycle that only lasts 500-1000 msec long, and then has a relatively long idle time before the next cycle begins. Current systems may not be able to differentiate between the active and in-active/idling cycle times, as the measurement tool would need to be significantly faster than the process itself in order to accurately measure it.

Even if a device is able to make measurements quickly enough current devices are not able to accurately identify the start and stop of an active cycle. At best existing devices may make a guess at when exactly the active cycle started, but this may lead to inconsistency in the data or may be more easily disrupted by noise or disruptions to the system.

Additionally, most manufacturing processes energy consumption tracking methods rely on looking at total energy consumption over a longer period of time, for example for the whole plant, or a manufacturing line or machine. The total energy consumption is then divided across the number of parts manufactured in order to get a rough estimate of energy consumption per part.

However even when looking at a specific machine multiple different parts may be manufactured over the course of a typical shift or across the day. This makes it nearly impossible to define and manage energy consumption for each unit part independently. This results in an inexact computation that cannot be used to create accurate assignment of total energy consumption on a part-by-part basis for a finished product like an automobile.

This is especially important as many governments set overall targets for carbon footprint emissions, and major companies may be assigned an individual carbon footprint emission target. For most businesses most of “their” carbon footprint emissions will actually come from their vendor chain, called “scope 3” emissions. Since scope 3 emissions are not generated in house the parent company must rely on reported figures which may or may not be accurate. This process is further complicated by a lack of standardization for managing and reporting the carbon footprint emissions from vendors. Businesses are then taxes for their carbon footprint emissions, sometimes including the emissions coming from their vendor chain. For these reasons there is a need for businesses to be able to conveniently track and understand carbon footprint emissions in a standardized way similar to how businesses track cost of goods or other manufacturing metrics.

### SUMMARY

In one or more embodiments there may be a method for determining the carbon footprint of a manufactured item. The method may begin by determining one or more subcomponent carbon footprint (UMX) values based on a carbon footprint associated with the one or more subcomponents. Then the subcomponent UMX value may be associated with the subcomponent through a subcomponent identifier. The process may then be repeated for each of one or more subsequent components and/or final products.

In some embodiments the additional carbon emissions caused by the manufacturing and/or assembling of the one or more subcomponents into the one or more components may be determined by taking data readings from the manufacturing process through one or more sensors, transferring from the one or more sensors to a digital signal processor the data readings, processing the data readings by the digital signal processor, and storing, in a first memory storage, the data readings processed by the digital signal processor. Energy consumption of the manufacturing process may then be determined based on the processed data readings by a processor and stored in a second memory storage.

In some embodiments the stored component UMX value may be associated with a component identifier in a database that is connected to an accounting & reporting program. One or more pricing proposals may be automatically generated, and each pricing proposal may include, for example, the monetary value and the UMX value associated with each of the one or more components.

In some embodiments the processor may determine a manufacturing process active start time and active end time and may further split the consumption data into active period energy consumption data and idle period energy consumption data based on the determined active start time and active end time. The active period energy consumption data may then be associated with a manufactured component.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

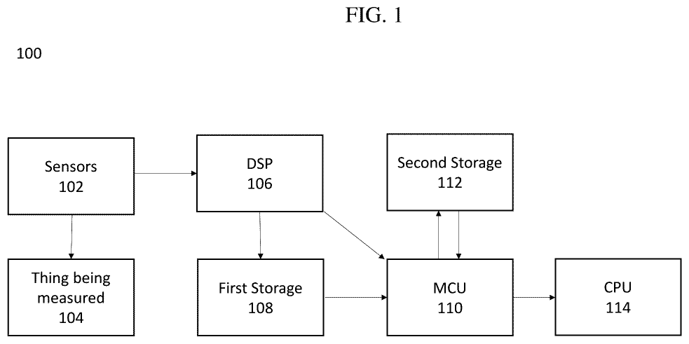

Exemplary FIG. 1 shows a system for measuring and tracking carbon footprint of manufactured goods.

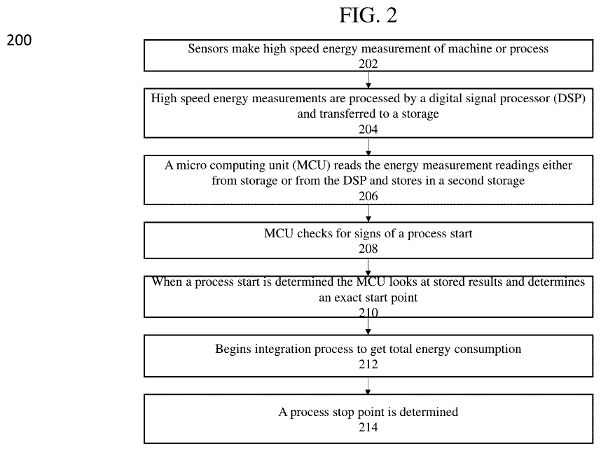

Exemplary FIG. 2 shows a method for measuring and tracking energy consumption of manufactured goods.

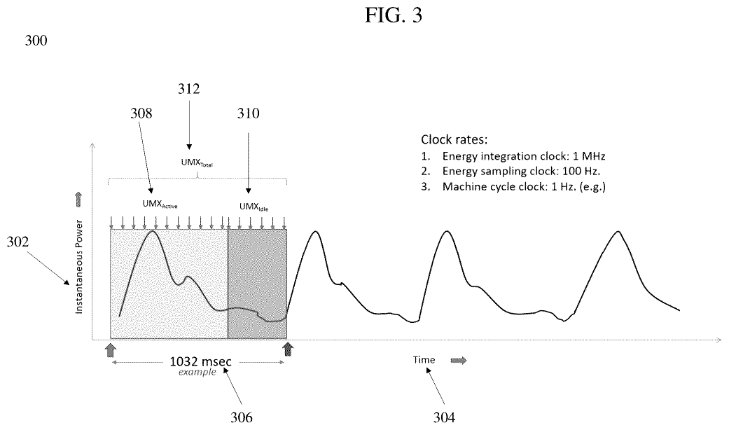

Exemplary FIG. 3 shows an exemplary power consumption over time graph as determined by the instrumentation node for measuring and tracking energy consumption of manufactured goods.

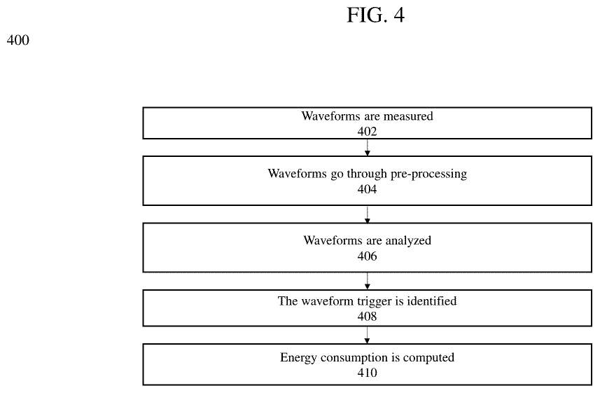

Exemplary FIG. 4 shows an exemplary machine learning method for computing energy consumption utilizing neural nets.

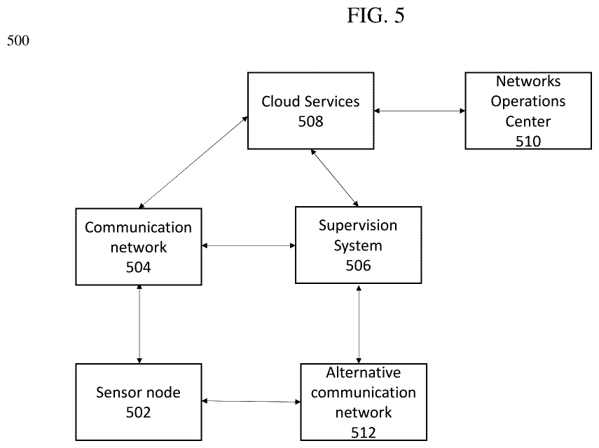

Exemplary FIG. 5 shows a maintenance mode for the system for measuring and tracking carbon footprint of manufactured good.

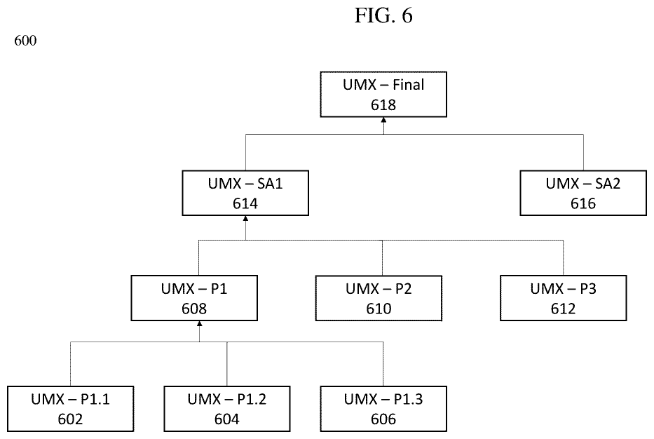

Exemplary FIG. 6 shows an exemplary flowchart for carbon footprint accounting in an exemplary multi-level vertical supply chain embodiment.

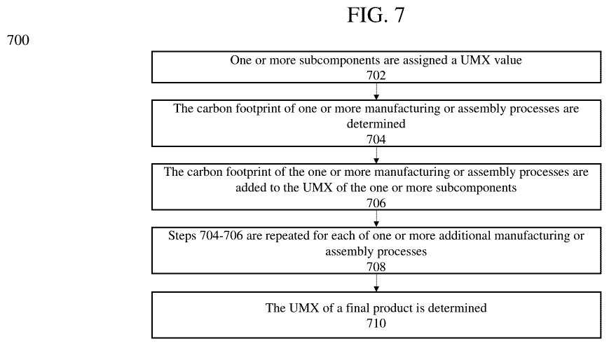

Exemplary FIG. 7 shows an exemplary method for determining carbon footprint of a final product.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, some of the embodiments described herein may be described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. Furthermore, the sequence of actions described herein can be embodied in a combination of hardware and software. Thus, the various aspects of the present invention may be embodied in a number of different forms, all of which have been contemplated to be within the scope of the claimed subject matter. In addition, for each of the embodiments described herein, the corresponding form of any such embodiment may be described herein as, for example, “a computer configured to” perform the described action.

As used herein parts of the system or method may be described with relation to a part being manufactured, however it may be understood that in other embodiments the systems and methods described may be used for other processes, including but not limited to, repairing or machining of existing parts, assembly of multiple parts, forging, manufacturing, etc.

As used herein, “active process” means when the assembly line or machine is active using energy in order to manufacture a part, while “non-active process” or “idle cycle” means the machine is resting in between manufacturing, though energy may still be consumed due to, for example, leakage current.

As used herein UMX means unit manufacturing carbon emissions and may be used interchangeably with carbon footprint (CFP) for an individual component.

Referring to exemplary FIG. 1, a system for measuring and tracking carbon footprint of manufactured goods 100 may be shown. The system for measuring carbon footprint 100 may contain one or more sensors 102. The sensors 102 may include, for example, IC energy meters, CT sensors, etc. A plurality of the sensors 102 may be combined into a sensor node, which may include, for example, a front end module that manages and makes sensor measurements, a compute module that processes data, and a transport module that applies security layers, and manages communication over a network. The sensors 102 may gather energy consumption information from a manufacturing process 104. The manufacturing process 104 may be a machine, assembly line, factory, etc. The sensors 102 may send the gathered energy consumption information to a digital signal processor (DSP) 106, which may be part of the compute module. The data taken by the sensors and read by the DSP 106 may be processed based on the DSP 106 clock, which may be, for example, 1 MHz, 100 KHz, 10 MHz, or any other clock-rate.

The system 100 may further include a first storage 108 that stores data values read by the sensors 102 and processed by the DSP 106. The first storage 108 may be, for example, a series of registers. The system 100 may further include a micro computing unit (MCU) 110 which may take the information stored in the first storage 108 and/or take information directly from the DSP 106. The MCU 110 may read the information from the DSP 106 and/or first storage 108 at the MCU 110 clock rate, which may be a clock rate one or more orders of magnitude less that the DSP 106 clock rate. For example, in an exemplary embodiment the DSP 106 clock rate may be 1 MHz while the MCU 110 clock rate may be 1 KHz or 100 Hz. The read information may be the amount of energy consumption used by the attached machine or process since the last reading (for example if the MCU 110 clock rate is 1 KHz then each reading would be 1 msec worth of energy consumption). The MCU 110 may then store the read information in a second storage 112. It may be contemplated that a different clock rate may be used for different purposes, for example a higher clock rate may provide more accurate information while a lower clock rate may reduce energy consumption of the measurement device. The second storage 112 may be, for example, a first in first out (FIFO) array or stack.

In an exemplary embodiment the DSP 106, first storage 108, MCU 110, second storage 112, and CPU 114 may all be contained on a same structure, for example a single integrated circuit board or printed circuit board. In other exemplary embodiments the DSP 106, first storage 108, MCU 110, second storage 112, and/or CPU 114 may be contained on two or more structures, with wired or wireless connections between the two or more structures that allow for transfer of data.

Referring to exemplary FIG. 2, a method for measuring and tracking energy consumption of manufactured goods 200 may be shown. In a first step 202, the sensors 102 may make high speed energy measurements of a machine or process. In a second step 204, the high speed measurements may be processed by the DSP 106 at the DSP 106 clock rate and be transferred to a first storage 108. In a third step 206, the MCU 110 may read the energy measurement readings from the first storage 108 and/or DSP 106 at the MCU 110 clock rate, and may store the energy measurement readings in the second storage 112. In a fourth step 208 the MCU 110 may check the energy measurements for signs of an active process start.

In an exemplary embodiment checking for the active process start may involve comparing the most recent read value against a baseline value to check if the recent read value shows an increase over the baseline value. If an increase is detected the MCU 110 may then track subsequent energy readings in order to determine if the increase is systemic, which may indicate the onset of the active process cycle as opposed to simple noise in the system being read or the measurement devices. The baseline value may be a preset value or may be a value determined by the system based on, for example, taking an average of all or part of previous readings or non-active cycle readings. In some embodiments the baseline value may be determined by machine learning (ML) or artificial Intelligence (AI).

In alternative exemplary embodiments detecting the active process start may be done based on an external trigger connected to the programmable logic controller (PLC) that controls the manufacturing equipment being measured, in some embodiments it may be contemplated that the external trigger may be offset to coincide with the start of the active cycle. In yet other embodiments a series of sensors or computer-vision cameras may be used to determine the position of the part(s) being manufactured, and may trigger the on-set of the active cycle based on the location of the part, it may be contemplated that the location based trigger may be offset in some embodiments. In some embodiments it may be contemplated that ML or AI may be used to determine the proper location or offset needed to trigger the on-set of the active cycle. In other exemplary embodiments the on-set may be triggered based on electrical readings of other components in the manufacturing process, for example in a forging embodiment the on-set may be triggered by reading a current surge in the motor circuit driving the forging hammer. The above are for exemplary purposes only, and in other circumstances one or more of the above and/or other processes may be used to trigger the active cycle on-set.

Still referring to FIG. 2, in a fifth step 210, when the process start point is determined the MCU 110 may look at the energy measurement data stored in the second storage in order to determine an exact start point. In an exemplary embodiment, this may be necessary as the process of checking for the active phase start may require some number of cycles to have already passed, therefore to increase accuracy the MCU 110 can look back at the previous cycles to find the actual start time and not just the previously determined start time.

In a sixth step 212, the MCU 110 may begin to integrate the energy readings from the second storage 112 starting from the exact start time determined in the fifth step 210. The integration of the energy readings may provide a total energy consumed over the time period integrated. In a seventh step 214, the MCU 110 may determine an active process end point. Determining the active-process end point may be done in any of the ways described for determining the active-process start point but done in reverse, for example instead of checking read values to see if they're above the baseline value the MCU 110 may instead check for when the read values fall below the baseline value. Similar may be done for each of the other processes described above, and as in the active-process start one or more of the described processes and/or other processes may be used. The process used to determine the active process end point may be the same as the process used to determine the active process start point, or may be a different process, for example the start-point could be determined based on sensors and computer-vision camera's while the end point is determined based on the baseline value comparison, or vice versa.

The MCU 110 may store the data in connection with each individual component manufactured. The stored data may include, for example but not limited to, the component manufactured, what machine or process was used to manufacture it, the integrated energy consumption data, the raw energy data, etc. In some embodiments the data may be stored so that extracting the data on the individual component shows only the energy consumption for that component. In other embodiments the total energy consumption may be overlayed with the data related to the components in question. In some embodiments energy consumption data may be provided for the entire process or factory rather than just an individual component. Energy consumption data may be separated into an active cycle and idle cycle component based on the start and stop end points determined in steps 208-214. In some embodiments sing part process energy content for active and idle periods may be excessive data and may be aggregated.

Referring to exemplary FIG. 3, an exemplary power consumption over time graph as determined by the instrumentation node for measuring and tracking energy consumption of manufactured goods 300 may be shown. The power consumption graph 300 may have an X-axis 302 that shown instantaneous power, and a Y-axis 304 that shows time. The power consumption graph 300 may show one or more power consumption cycles 306 which may be broken into active cycle energy consumption 308 and idle energy consumption 310. The cycle energy consumption 308 and idle energy consumption 310 may make a total cycle energy consumption 312. It may be understood that in some embodiments the time of the idle cycle may be much longer than the time of the active cycle, for example the active cycle may only last a few seconds while the idle cycle may last a minute or more. It may be understood that the above method may be used for any discrete or unit manufacturing process, whether at high speeds or low speeds.

It may be understood that in some embodiments statistical aggregations of like data may also be used to determine power consumption. For example, an average of active and idle period energy may be computed over a number of periods, where the number of period may be set depending on the circumstances, for example the type of process being measured, what the data is being used for, etc. Such aggregations may be, for example, separate aggregations of just active periods or just idle period or may be aggregations of total active+idle period data. Aggregated data may then be associated with, for example, a batch of components, or a line or factory rather than a single part. In some embodiments both the aggregated data and the underlying single part parameters may be recorded and available, and may be utilized for purposes of, for example, system diagnostics or other special needs. In some embodiments additional statistical measures may be computed and stored, for example standard deviations. In some embodiments the MCU 110 may be connected to a data source that provides information on electric energy supply for the process or machine being monitored. For example, during mid-day the electrical power in the grid may have a relatively high amount of power derived from solar power, while at night the electrical supply may come primarily from a coal fired baseline plant. The MCU 110 may combine this data with the energy consumption determined by the method 200 in order to determine a total carbon footprint calculation.

In some embodiments the MCU 110 may also track trends in the energy consumption data over time order to identify one or more potential causes of concern. For example, in an exemplary embodiment the MCU 110 may monitor active cycle energy consumption and flag an issue and/or notify a user, operator, or other person if causes for concern are detected. One cause for concern may be, for example, a steadily increasing active energy consumption from cycle to cycle, which may be indicative of excessive wear on the manufacturing tool. In another embodiment excessive energy consumption during idle periods may indicate that operators are not efficiently loading and unloading parts on the machine or there are mechanical or electrical issues causing higher than expected leakage.

In an exemplary forging embodiment, variations in incoming material, either due to improper pre-treatment or improper composition of the material, to the workstation may result in fluctuations in energy consumption during the active cycle, this may be flagged by the system in order to indicate that material quality needs to be checked or verified. In other exemplary embodiments changes in time between active or idle cycles may be monitored in order to determine if there has been an improper cycle drift, which may be flagged in order to indicate that cycle timing needs to be checked or verified. In some embodiments the system may be set up to look for one of the causes for concern or may look for multiple causes for concern. In some embodiments ML or AI may be used to track the causes for concern and further to notify the user, operator, or other person if a cause for concern is detected. In some embodiments the AI or ML may make automatic decisions based on discovered causes for concern, for example the system may slow or pause manufacturing until acknowledged by one or more of the notified individuals.

In an exemplary embodiment the processed data may be passed to a CPU 114, either through wired connection or wireless transmission, for example through an RF transceiver. The CPU 114 may then apply appropriate security frameworks to the data packets and construct them into data units that can be transmitted over a network, for example an RF network. The data units may be received by a gateway which may, for example, do one or more of deconstructing the data units to extract data packets, affixing time stamps and ID's, sending information over a cloud or internet service, etc.

Information on the ML and AI systems may now be discussed. In an exemplary embodiment the ML or AI system may be, for example, an unsupervised realtime waveform classification system. The unsupervised realtime waveform classification system may classify measured waveforms according to a set of standard waveforms. Input waveforms may be, for example, “weak detection, strong noise” waveforms. In some embodiments the neural networks utilized by the ML and/or AI systems may be, for example, a fully connected neural network, a recurrent neural network, or a convolutional neural network. It may be understood that in other embodiments different forms of ML and/or AI may be used as appropriate.

Referring to exemplary FIG. 4, an exemplary ML method for computing energy consumption utilizing neural nets 400 may be shown. In a first step 402 the input waveform may be measured, for example by utilizing the sensors 102. In a next step 404 the measured waveforms may go through a pre-processing step. The pre-processing step may include, but is not limited to, de-noising, baseline drift removal, cleaning the waveform, doing period segmentation, and/or normalizing the waveform. In a next step 406 the processed waveform may then be analyzed against a reference waveform. The analysis may, for example, check for a pass or fail based on error counts in order to determine relevance of the measured waveform. In another embodiment the comparison may looks at the difference in the data through, for example, RMSE analysis to determine the relevance of the data. In an exemplary embodiment RMSE analysis may be, for example

$$MSE = \frac{1}{n} {\sum }_{i = 1}^{n} {( {Y}_{i} - {\hat{Y}}_{i} )}^{2} .$$

In a next step 408 the waveform trigger, which may be for example the time stamp when a significant increase in energy detection begins, may be identified, for example as described above. In a final step 410, energy consumption data may be computed. In an exemplary embodiment waveform analysis may be used to help detect anomalies in the process for failure detection.

Referring to exemplary FIG. 5 a maintenance mode system 500 may be show. In an exemplary embodiment the system may be able to switch to a maintenance mode 500. The maintenance mode 500 may, for example, facilitate remote updating of a sensor node 502. The sensor node 500 may be part of a normal operations communication network 504 which may be, for example, Bluetooth low energy (BLE) in order to save on energy consumption. The normal operations communication network may be overseen by a supervision system 506 which may be, for example, a mesh hypervisor system. The normal operations communication network 504 may communication with a cloud services network 508, which may further communicate to a networks operations center 510. The networks operations center 510 may disseminate updates or other information to the sensor node 502.

In an exemplary embodiment the maintenance mode 500 may utilize an alternative communication network 512 which may be, for example, high-speed Wi-Fi or other high-speed data connection the supervisor system 506 to the sensor node 102. The high-speed connection may allow for direct updates to the sensor node 502 from the network operations center 510. In an exemplary embodiment the sensor node 502 may be set to maintenance mode by a Bluetooth or other command from the communication network 504. A separate command, from the same or different source, may end the maintenance mode.

In an exemplary embodiment a method of determining energy consumption and carbon footprint of a manufactured good may be provided. As described above a manufactured component may have an energy consumption determined during a manufacturing stage. In some embodiments the energy consumption may be attributed to the component as a unit manufacturing carbon footprint (UMX) value. In some embodiments the UMX value may be designated as UMXₜₒₜₐₗ and may be split between UMX_{active} and UMX_{idle} as described above. It may be understood that a single component may go through multiple manufacturing stages or processes, or a single end product may be made of multiple manufactured components.

In some exemplary embodiments the UMX value may be an aggregate UMX value, for example a first stage of manufacturing may give a UMX(1) value, while a second manufacturing stage gives a UMX(2) value. The UMX(aggregate) value for the component may then be UMX(1)+UMX(2). The UMX(aggregate) may then be assigned to the manufactured component as an attribute of that component. In some embodiments the aggregate may only consider the UMX_{active} values, while in other embodiments the aggregate may be an aggregate of the UMXₜₒₜₐₗ and/or UMX_{idle} values, depending on the application.

In some exemplary embodiments the assigned UMX(aggregate) for each component may travel with the component through, for example, enterprise, organization, and/or IT systems; which may be, for example, an enterprise resource planning (ERP) system, a software as a service (SaaS) system, and/or a manufacturing execution system (MES). One or more of the systems may be integrated with the exemplary embodiment through, for example, as an API that makes data request calls to one or more exemplary databases; through streaming data feeds that provide subscription-based input data into any other system; integrated into spreadsheets through, for example, excel; integrated into an accounting system such as, for example, QuickBooks, integrated into a CAD drawing system such as AutoCAD by, for example, having the carbon footprint of each component available as a part detail, integrated into artificial intelligence and/or business intelligence systems, and/or integrated into various reporting software such as Zoho or AWS Quicksight.

In some embodiments the UMX(aggregate) may be further combined with energy production data in order to determine a carbon footprint consumption. For example, if a component was constructed at a factory powered by a combination of solar power and coal that data may be combined with the energy consumption to determine an exact carbon footprint. In some embodiments the energy production data may be tracked over time, and the energy production and any given time may be combined with the UMX values that correspond to that time. The use of the enterprise, organization, and/or IT systems may allow for the carbon footprint consumption data to be tracked for individual end products based on the chain on components used during manufacturing, and it may be recorded and tracked with the same methodologies used for, for example, cost management systems.

In an exemplary embodiment the UMX values for each process and each component may be stored and used as part of a product data retention chain of custody, and may be used to review manufacturing conditions, for example in the case of service issues that necessitate review. In some embodiments the system may be set up to look for one or more causes for concern at an enterprise level. In some embodiments ML or AI may be used to track the causes for concern at an enterprise level and further to notify the user, operator, or other person if a cause for concern is detected. In some embodiments the tracked data may be compared with other external metrics, for example compared against government instituted carbon footprint emission guidelines and regulations. In some embodiments the user, operator, or other person may be notified if the tracked data shows that their may be compliance issues, for example exceeding carbon footprint guidelines.

The method and system may now be described as implemented in an exemplary multi-level vertical supply integration embodiment. In an exemplary embodiment the aggregation may start at the raw materials input stage, where the raw material is assigned a UMX value equal to the carbon footprint created by extracting the raw material. Each of a plurality of vendors may then add a UMX process step to the incoming material or part, equal to the carbon footprint generated by processing the material or manufacturing the part. It may be understood that in an embodiment this process is additive and the UMX of the part is simply added to at each part, therefore the existing UMX from each vendor may be equal to the incoming UMX of the part or material+UMX added by that vendor.

Now referring to exemplary FIG. 6, an exemplary flowchart for carbon footprint accounting in an exemplary multi-level vertical supply chain embodiment 600 may be shown. In a first level of the multi-level vertical supply chain there may be a plurality of subcomponents, for example a first subcomponent P1.1 602, a second subcomponent P1.2 604, and a third subcomponent P1.3 606, each of which may be assigned a first UMX value. Each of the subcomponents may be part of a component, for example P1 608, which may have a UMX value equal to the UMX's of P1.1 602, P1.2 604, P1.3 606, plus any additional carbon footprint is added in the manufacturing of the component. There may also be a plurality of additional components, for example P2 610 and P3 612, each of which has an assigned UMX value and each of which may themselves have a plurality of subcomponents. The plurality of components may be assembled into a plurality of subassemblies, for example the components P1 608, P2 610, and P3 612 may be part of a subassembly SA1 614, which may have a UMX equal to each of the components plus any additional carbon footprint generated in the assembly process. There may be a plurality of other subassemblies, for example another subassembly SA2 616, each of which may have a plurality of components. Finally, there may a final product 618, which may have a UMX equal to each subassembly plus any additional carbon footprint generated in the assembly of the final product.

It may be understood that in some embodiments there may be more or less than 4 vertical levels, and in some embodiments there may be any number of components in each level, for example a car may have tens of thousands of individual subcomponents at the first level, and the individual subcomponents may go through dozens of levels of manufacturing and/or assembly.

Referring to exemplary FIG. 7, an exemplary method for determining carbon footprint of a final product 700 may be shown. In a first step 702, the UMX values of one or more subcomponents may be determined, and the determined UMX value may be assigned to each subcomponent as an attribute of that subcomponent. In a next step 704 the carbon footprint generated by one or more manufacturing or assembly processes associated with one or more of the one or more subcomponents may be determined. In a next step 706, The carbon footprint determined in step 704 may be added to the related one or more subcomponent UMX values. In a next step 708, steps 704-706 may be repeated for each assembly or manufacturing process that the one or more subcomponents go through, including, for example, the step of assembling the one or more subcomponents into the final product. In a final step 710 the UMX of a final product may be determined based on the aggregation of the one or more subcomponents.

In some embodiments the determined UMX value for each of the one or more subcomponents, each of the one or more components, and/or each of one or more final products may be integrated with, for example, an accounting and reporting program. In some embodiments one or more suppliers may send integrated pricing proposals to a manufacturer or other entity. The pricing proposal may include information on, but is not limited to, UMX values, prices of the materials and/or delivery, quality details, weights, size, quantities, etc. In an exemplary embodiment a pricing proposal may be automatically generated based on one or more of the above factors. In an exemplary embodiment a manufacturer or other entity may be presented with two or more competing price proposals. A price proposal may be selected automatically, based either on pre-determined thresholds or rules and/or by AI or ML. The criteria used to select a price proposal may be, for example but not limited to, the lowest UMX, the lowest price, the lowest average price and UMX, the lowest price where the UMX is below a specified threshold or vice versa, and/or an optimized consideration taking into account a plurality of factors including price, UMX, quality, quantity, etc.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for determining the carbon footprint of a manufactured item; the method comprising:
determining one or more subcomponent carbon footprint (UMX) values based on a carbon footprint associated with the one or more subcomponents;
associating the subcomponent UMX values with the subcomponent through a subcomponent identifier;
determining a component UMX value for one or more components comprised of at least one of the one or more subcomponents, wherein the component UMX value is the combination of the UMX value of each subcomponent combined with an additional carbon emissions caused by manufacturing and/or assembling of the one or more subcomponents into the one or more components; and
associating the component UMX value with the component through a component identifier;
wherein the additional carbon emissions caused by the manufacturing and/or assembling of the one or more subcomponents into the one or more components are determined by;
taking data readings from the manufacturing process through one or more sensors;
transferring, from the one or more sensors to a digital signal processor, the data readings;
processing the data readings by the digital signal processor;
storing, in a first memory storage, the data readings processed by the digital signal processor;
determining energy consumption of the manufacturing process based on the processed data readings by a processor; and
storing, in a second memory storage, the energy consumption data determined by the processor.

2. The method for determining the carbon footprint of a manufactured item of claim 1, further comprising dividing the energy consumption of the manufacturing process by the number of components manufactured in order to determine an average energy consumption data per manufactured component;
wherein the stored energy consumption data is at least the average energy consumption data.

3. The method for determining the carbon footprint of a manufactured item of claim 1, wherein the component identifier that the component UMX value is associated with also contains at least monetary cost of the component.

4. The method for determining the carbon footprint of a manufactured item of claim 1, wherein the component identifier that the component UMX value is associated with is an existing component identifier in one of an enterprise resource planning or a manufacturing execution system.

5. The method for determining the carbon footprint of a manufactured item of claim 1, further comprising storing each of a plurality of component UMX values and using the plurality of stored UMX values as part of a product data retention chain of custody.

6. The method for determining the carbon footprint of a manufactured item of claim 5, further comprising monitoring the product retention chain of custody for causes of concern, wherein the causes of concern include one or more of manufacturing conditions and service issues.

7. The method for determining the carbon footprint of a manufactured item of claim 6, further comprising notifying a user if the cause of concern is detected.

8. The method for determining the carbon footprint of a manufactured item of claim 5, further comprising monitoring the product data retention chain of custody against carbon footprint emission guidelines; and
notifying the user if the carbon footprint emission guidelines are exceeded.

9. A method for determining the carbon footprint of a manufactured item; the method comprising:
determining one or more subcomponent carbon footprint (UMX) values based on a carbon footprint associated with the one or more subcomponents;
associating the subcomponent UMX value with the subcomponent through a subcomponent identifier;
determining a component UMX value for one or more components comprised of at least one of the one or more subcomponents, wherein the component UMX value is the combination of the UMX value of each subcomponent combined with an additional carbon emissions caused by manufacturing and/or assembling of the one or more subcomponents into the one or more components; and
associating the component UMX value with the one or more components through a component identifier;
storing the component UMX value with the associated component identifier in a database that is connected to an accounting & reporting program; and
automatically generating a pricing proposal wherein, the pricing proposal includes at least the monetary value and the UMX value associated with each of the one or more components.

10. The method for determining the carbon footprint of a manufactured item of claim 9; wherein the pricing proposal is automatically generated for each of two or more vendors.

11. The method for determining the carbon footprint of a manufactured item of claim 10; wherein the pricing proposal that optimizes carbon footprint is automatically selected.

12. The method for determining the carbon footprint of a manufactured item of claim 10; wherein the pricing proposal selection is determined automatically by artificial intelligence (AI) or machine learning (ML).

13. The method for determining the carbon footprint of a manufactured item of claim 9; further comprising storing each of a plurality of component UMX values and using the plurality of stored UMX values as part of a product data retention chain of custody.

14. The method for determining the carbon footprint of a manufactured item of claim 12; further comprising monitoring the product retention chain of custody for causes of concern, wherein the causes of concern include one or more of supplier conditions and service issues.

15. The method for determining the carbon footprint of a manufactured item of claim 14, further comprising notifying a user if the cause of concern is detected.

16. The method for determining the carbon footprint of a manufactured item of claim 12; further comprising monitoring the product data retention chain of custody against carbon footprint emission guidelines; and
notifying the user if the carbon footprint emission guidelines are exceeded.
